(19) United States
(12) Patent Application Publication
(10) Pub. No.: US 2009/0190517 A1
(43) Pub. Date: Jul. 30, 2009

(54) WIRELESS COMMUNICATION SYSTEM, BASE STATION CONTROL DEVICE, WIRELESS BASE STATION, AND METHOD OF ASSIGNING A PHYSICAL CHANNEL

(76) Inventor: IKUO MAEZAWA, Saitama (JP)

Correspondence Address: NEC CORPORATION OF AMERICA, 6535 N. STATE HWY 161, IRVING, TX, 75039, US

(21) Appl. No.: 12/356,346

(22) Filed: Jan. 20, 2009

(30) Foreign Application Priority Data
Jan. 25, 2008 (JP) 2008-014996

(51) Int. Cl. H04H 20/71

(52) U.S. Cl. 370/312

(57) ABSTRACT

A wireless communication system comprises: a wireless base station thereof having a first cell that provides a multicast/broadcast service and a second cell with at least a portion thereof overlapping with said first cell, said wireless communication system further comprises: a determining unit that for determines whether or not a mobile station is located in a service area of said second cell; and an assigning unit that assigns a multicast/broadcast service physical channel corresponding to said second cell when said mobile station is located in said service area of said second cell and assigns a multicast/broadcast service physical channel corresponding to said first cell when said mobile station is not located in said service area of said second cell.

### REFERENCE TO RELATED APPLICATION

This application is based upon and claims the benefit of the priority of Japanese patent application No. 2008-014996, filed on Jan. 25, 2008, the disclosure of which is incorporated herein in its entirety by reference thereto.

### FIELD OF THE INVENTION

The present invention relates to a wireless communication system, a base station control device, a wireless base station, and a method of assigning a physical channel in the wireless communication system. More specifically, the invention relates to a wireless communication system, a base station control device, a wireless base station, and a method of assigning a physical channel in the wireless communication system that provide a Multimedia Broadcast And Multicast Service (hereinafter referred to as “MBMS”) specified in a 3GPP (3rd Generation Partnership Project).

### BACKGROUND

The MBMS provides a broadcast service and a multicast service to a plurality of mobile stations, with one physical channel shared among a plurality of mobile stations. Since power of a channel through which transmission is performed must be determined in accordance with a mobile station located far from a wireless base station in view of properties of broadcasting and multicasting, a lot of radio resources are needed. Especially when large capacity contents and applications are delivered in the future, a radio resource shortage in the base station is expected. Thus, establishment of a method of efficiently using radio resources is an urgent matter.

Patent Document 1 discloses a configuration in which a symbol is transmitted using two code sequences that have hierarchically different error rates and transmission power is increased or decreased according to responses from mobile stations so that a ratio of mobile stations capable of receiving information with high quality (with a small error rate) reaches a target value.

Patent Document 2 proposes a configuration in which, from a base station having two cells with different cell radiuses, base data is transmitted to a cell region (first cell) having a large cell radius and enhanced data is transmitted to a cell region (second cell) inside the first cell, thereby differentiating data receiving performance according to the position of a mobile station.

Patent Document 3 discloses a radio resource assignment system in which radio resource assignment is performed to a mobile terminal according to an arrival time of a signal received at a base station from the mobile terminal. More specifically, in the method in Patent Document 3, control is performed in which a mobile station in the vicinity of the base station where an arrival time of a received signal is short is assigned to a radio zone having low transmission power and a mobile station located far from the base station is assigned to a radio zone having high transmission power.

Patent Document 4 discloses a mobile communication system in which, based on mobile station uplink delay information, a mobile station that is present in the vicinity of a cell boundary is detected, and downlink control channel transmission power of each base station device is controlled based on downlink control channel receiving level information obtained from the mobile station.
[Patent Document 1] JP Patent Kokai Publication No. JP-P-2004-208153A
[Patent Document 2] JP Patent Kohyou Publication No. JP-P-2005-524333A
[Patent Document 3] JP Patent Kokai Publication No. JP-P-2007-194755A
[Patent Document 4] JP Patent Kokai Publication No. JP-P-2007-13351A

### SUMMARY OF THE DISCLOSURE

The entire disclosures of Patent Documents 1 to 4 are incorporated herein by reference thereto. The following analyses are given by the present invention.

The methods described in Patent Documents 1 and 2 assume occurrence of a mobile station that cannot receive a high-quality service. Thus, there is a problem that the high-quality service cannot be provided to any mobile station. The method described in Patent Document 3 is also configured to implement high-quality or high-speed data transfer to a mobile station located in the vicinity of the base station, as described in paragraph [0025] of the document.

In the method described in Patent Document 4, based on the downlink control channel receiving level information obtained from the mobile station located in the cell boundary, the downlink control channel transmission power is changed, in place of cell design based on a measurement result of the electrical field strength of a cell that has been performed hitherto. When the mobile station located in the cell boundary is far from the base station, a lot of radio resources would be naturally needed.

In short, there is a problem that when the transmission power is determined in accordance with a mobile station located far from the wireless base station, the radio resources are wastefully consumed, and when the transmission power is determined in accordance with a mobile station located in the vicinity of the wireless base station, the radio resources can be reduced, but a stable service cannot be provided to the mobile station located far from the wireless base station.

The present invention has been made in view of the circumstances described above. It is an object of the present invention to provide a wireless communication system, a base station control device, a wireless base station, and a method of assigning a physical channel capable of providing a high-quality service to both of a mobile station located in the vicinity of a base station and a mobile station located far from the base station in view of both of the mobile stations.

According to a first aspect of the present invention, there is provided a wireless communication system comprising a wireless base station thereof having a first cell that provides a multicast/broadcast service and a second cell with at least a portion thereof overlapping with the first cell. The wireless communication system includes:

a determining unit for determining whether or not a mobile station is located in a service area of the second cell; and

a assigning unit for assigning a multicast/broadcast service physical channel corresponding to the second cell when the mobile station is located in the service area of the second cell and assigning a multicast/broadcast service physical channel corresponding to the first cell when the mobile station is not located in the service area of the second cell.

According to a second aspect of the present invention, there is provided a base station control device of a wireless communication system with a wireless base station thereof having a first cell that provides a multicast/broadcast service and a second cell with at least a portion thereof overlapping with said first cell. The base station control device comprises:

a determining unit for determining whether or not a mobile station is located in a service area of the second cell; and

an assigning unit for assigning a multicast/broadcast service physical channel corresponding to the second cell when the mobile station is located in the service area of the second cell and assigning a multicast/broadcast service physical channel corresponding to the first cell when the mobile station is not located in the service area of the second cell.

According to a third aspect of the present invention, there is provided a wireless base station device that transmits to the base station control device described above information for determining whether or not a mobile station is located in the service area of the second cell.

According to a fourth aspect of the present invention, there is provided a mobile station device that transmits to the base station control device described above information for determining whether or not the mobile station device is located in the service area of the second cell.

According to a fifth aspect of the present invention, there is provided a method of assigning a physical channel in a wireless communication system with a wireless base station thereof having a first cell that provides a multicast/broadcast service and a second cell with at least a portion thereof overlapping with the first cell. The method comprises:

determining whether or not a mobile station is located in a service area of the second cell; and

assigning a multicast/broadcast service physical channel corresponding to the second cell when the mobile station is located in the service area of the second cell and assigning a multicast/broadcast service physical channel corresponding to the first cell when the mobile station is not located in the service area of the second cell.

The meritorious effects of the present invention are summarized as follows.

According to the present invention, a high-quality service can be provided to a mobile station located in the vicinity of the wireless base station and a mobile station located far from the base station. The reason for the effect is that a configuration is adopted where radio resources of the wireless base station are distributed in view of a distance from the wireless base station and assigned to respective mobile stations.

### BRIEF DESCRIPTION OF THE DRAWINGS

FIG. 1 is a diagram showing a schematic configuration of a wireless communication system according to a first exemplary embodiment of the present invention;

FIG. 2 is a block diagram showing a configuration example of a wireless base station in the first exemplary embodiment of the present invention;

FIG. 3 is a flowchart showing an operation of a base station control device in the first exemplary embodiment of the present invention;

FIG. 4 is a block diagram showing a configuration example of a mobile station in a second exemplary embodiment of the present invention; and

FIG. 5 is a flowchart showing an operation of a base station control device in the second exemplary embodiment of the present invention.

### PREFERRED MODES OF THE INVENTION

Next, a preferred mode for carrying out the present invention will be described in detail with reference to drawings.

### First Exemplary Embodiment

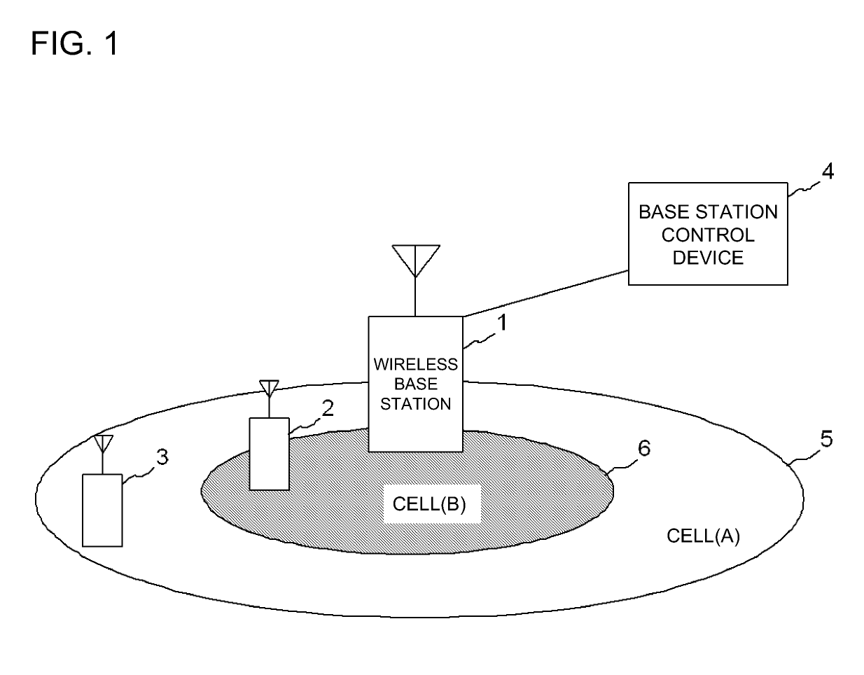

First, a first exemplary embodiment of the present invention that determines a physical channel to be assigned to a mobile station based on information sent from a wireless base station will be described. FIG. 1 is a diagram showing a schematic configuration of a wireless communication system according to the first exemplary embodiment of the present invention. Referring to FIG. 1, the configuration of the wireless communication system including a wireless base station that supports two types of physical channels belonging to cells with different cell radiuses is shown.

A wireless base station 1 performs wired-to-wireless conversion in accordance with control of a base station control device 4, and transmits/receives broadcast/multicast data through a wireless channel corresponding to each cell to/from each of mobile stations 2 and 3 located in two cells 5 and 6 having different cell radiuses.

Each of the mobile stations 2 and 3 is a portable terminal such as cellular phone terminal or a PDA (Personal Digital Assistant), which has a transmitting/receiving function and a reproduction function of multimedia data such as video and audio data included in the broadcast/multicast data delivered from the wireless base station 1.

The base station control device 4 controls the wireless base station 1, performs individual wireless channel assignments for the mobile stations 2 and 3, assigns a physical channel through which broadcasting/multicasting is performed and performs hand-over control. The base station control device 4 holds threshold values for assigning the physical channel through which broadcasting/multicasting is performed. The base station control device 4 determines a physical channel to be assigned, based on comparison between each of the thresholds and transmitting power information (Pue) received from the wireless base station 1.

A cell(A) 5 covers a wide-range area outside a cell(B) 6. A cell(B) 6 is located inside the cell(A) 5, and covers an area in the vicinity of the wireless base station 1. Accordingly, the cell(B) 6 is included in the cell(A) 5. In the cell(A) 5, broadcasting/multicasting is performed through a first physical channel. In the cell(B) 6, broadcasting/multicasting is performed through a second physical channel. Though the following description is given, assuming that downlink MBMS SCCPCHs (Secondary Common Control Physical Channels) are used for two physical channels, the number of the types of physical channels may also be increased.

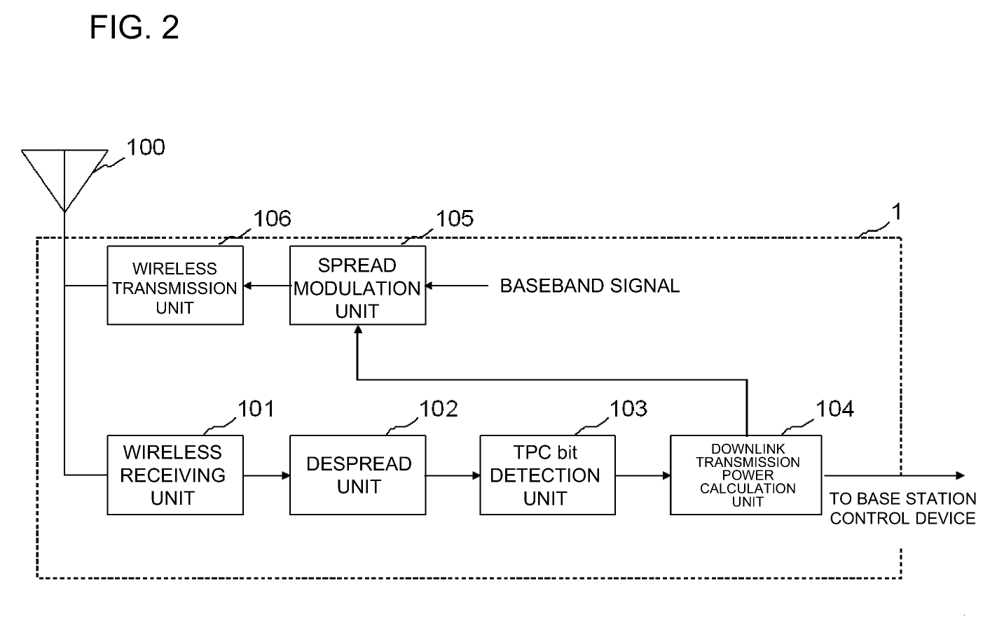

FIG. 2 is a block diagram showing a configuration example of the wireless base station 1 in the first exemplary embodiment of the present invention. Referring to FIG. 2, the wireless base station including an antenna 100, a wireless receiving unit 101, a despread unit 102, a TPC bit detection unit 103, a downlink transmission power calculation unit 104, a spread modulation unit 105, a wireless transmission unit 106 is shown.

The antenna 100 performs high-frequency signal transmission/reception with each of the mobile stations 2 and 3.

The wireless receiving unit 101 performs frequency conversion of a high-frequency signal received through the antenna 100 into an intermediate-frequency signal, and further converts the received signal to a digital signal through A/D (Analog to Digital) conversion.

The despread unit 102 performs despread and Rake synthesis of the digital signal from the wireless receiving unit 101.

The TPC bit detection unit 103 detects a TPC (Transmit Power Control) bit from received data after the RAKE synthesis through a DPCH (Dedicated Physical Channel). The TPC (Transmit Power Control) bit is herein information for controlling increase/decrease of downlink transmission power transmitted from each of the mobile stations 2 and 3.

The downlink transmission power calculation unit 104 calculates transmission power for controlling increase/decrease of the power of a high-frequency signal to be transmitted to each of the mobile stations 2 and 3, based on the information on the TPC bit, and outputs transmission power information to the spread modulation unit 105. Further, the downlink transmission power calculation unit 104 notifies transmission power information (Pue) on each of the mobile stations 2 and 3 to the base station control unit 4.

The spread modulation unit 105 performs spread and modulation processing on an encoded baseband signal to each of the mobile stations 2 and 3, based on the transmission power information from the downlink transmission power calculation unit 104, and outputs the spread modulated signal to the wireless transmission unit 106.

The wireless transmission unit 106 converts the spread modulated signal to the high-frequency signal and transmits the high-frequency signal to each of the mobile stations 2 and 3 through the antenna 100.

The above description was made about the configuration of the wireless base station 1. Since configurations well known to those skilled in the art may be adopted for the other configurations in the wireless base station, a description of the other configurations will be omitted, which may be referred to many publications available including those incorporated herein.

Next, an operation of the base station control device 4 in this exemplary embodiment, which operates based on the transmission power information (Pue) notified from the downlink transmission power calculation unit 104 of the wireless base station 1 described above, will be described.

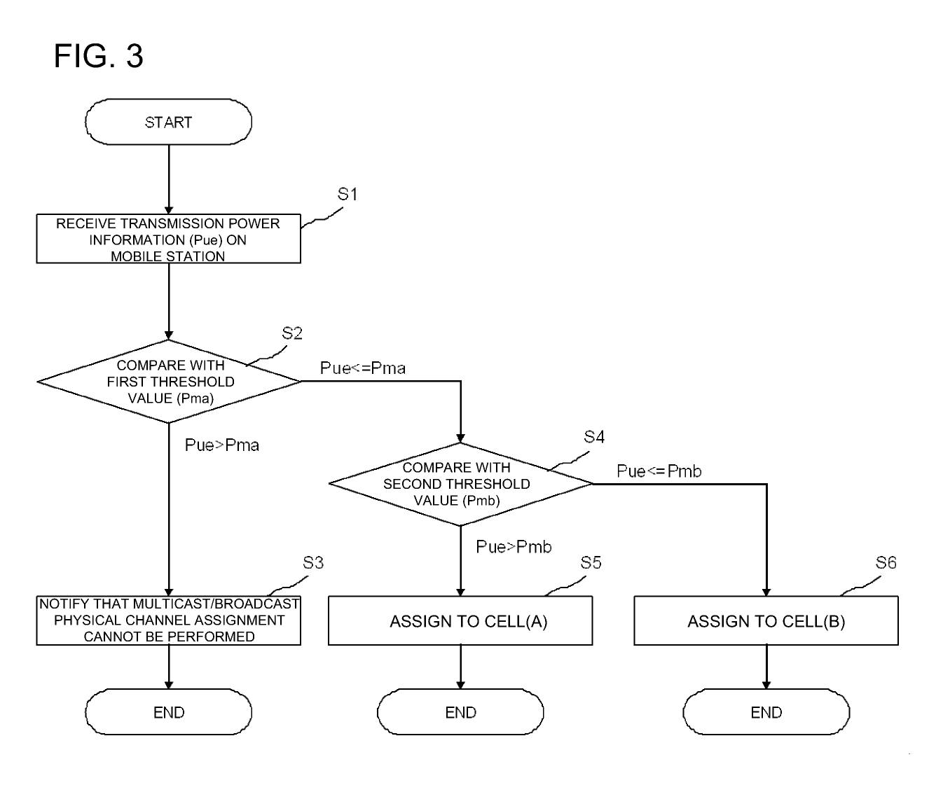

FIG. 3 is a flowchart showing the operation of the base station control device in the first exemplary embodiment of the present invention. Referring to FIG. 3, when the transmission power information (Pue) is supplied to the base station control device 4 from a wireless base station 1 (in step S1), the base station control device 4 first compares the transmission power information on the pertinent mobile station with a first threshold value (in step S2). As the first threshold value, SCCPCH transmission power information (Pma) on the cell(A) 5 having a large cell radius may be employed.

When it is found that the transmission power information (Pue) on the mobile station is larger than the first threshold (Pma) as a result of the comparison, the base station control device 4 determines that the pertinent mobile station is located in a position to which no physical channel cannot be assigned (outside a service area) (because data through a physical channel having lower power than the transmission power information (Pue) issued by the mobile station cannot be received by the mobile station). Then, the base station control device 4 notifies a host device and the mobile station that multicast/broadcast physical channel (SCCPCH) assignment cannot be performed (in step S3).

When the transmission power information (Pue) on the mobile station is equal to or lower than the SCCPCH transmission power information (Pma), the base station control device 4 compares the transmission power information (Pue) on the mobile station with a second threshold value (in step S4). As the second threshold value, SCCPCH transmission power information (Pmb) on the cell(B) 6 having a small cell radius may be used.

When the transmission power information (Pue) on the mobile station is larger than the second threshold value (Pmb) as a result of comparison, the base station control device 4 determines that the pertinent mobile station is located in the service area specific to the cell(A) 5 with the large cell radius (because the mobile station cannot receive data through a physical channel having lower power than the transmission power information (Pue) issued by the mobile station), and assigns a physical channel (SCCPCH) corresponding to the cell(A) 5 to the mobile station (in step S5).

On the contrary, when the transmission power information (Pue) on the mobile station is equal to or less than the second threshold value (Pmb), the base station control device 4 determines that the mobile station is located in the service area of the cell(B) 6 with the small cell radius, and assigns a physical channel (SCCPCH) corresponding to the cell(B) 6 to the mobile station (in step S6).

As described above, the base station control device 4 compares the transmission power information (Pue) with each of the first and second threshold values, and determines the physical channel (cell) to be assigned to the mobile station. As described above, this exemplary embodiment can assign different physical channels to a mobile station located in the vicinity of the wireless base station 1 and a mobile station located far from the wireless base station 1, thereby providing a high-quality service to each of the mobile stations. Further, with the arrangement described above, radio resources under management of the wireless base station 1 can also be distributed, thereby allowing prevention of congestion.

Further, in this exemplary embodiment, transmission power of a specific physical channel for multicasting/broadcasting (transmission power of the cell(B) in FIG. 1) can be reduced at a time of cell design. Thus, residual power resulting from transmission power reduction or a radio resource can be assigned to other resources. The radio resources can be thereby effectively utilized.

### Second Exemplary Embodiment

Next, a description will be given about a second exemplary embodiment of the present invention where DPCH transmission power information is not notified from a wireless base station but a physical channel to be assigned to a pertinent mobile station is determined based on information sent from the mobile station.

Since the basic configuration of the second exemplary embodiment of the present invention is the same as the configuration of the first exemplary embodiment shown in FIG. 1, a detailed description will be given below about a mobile station.

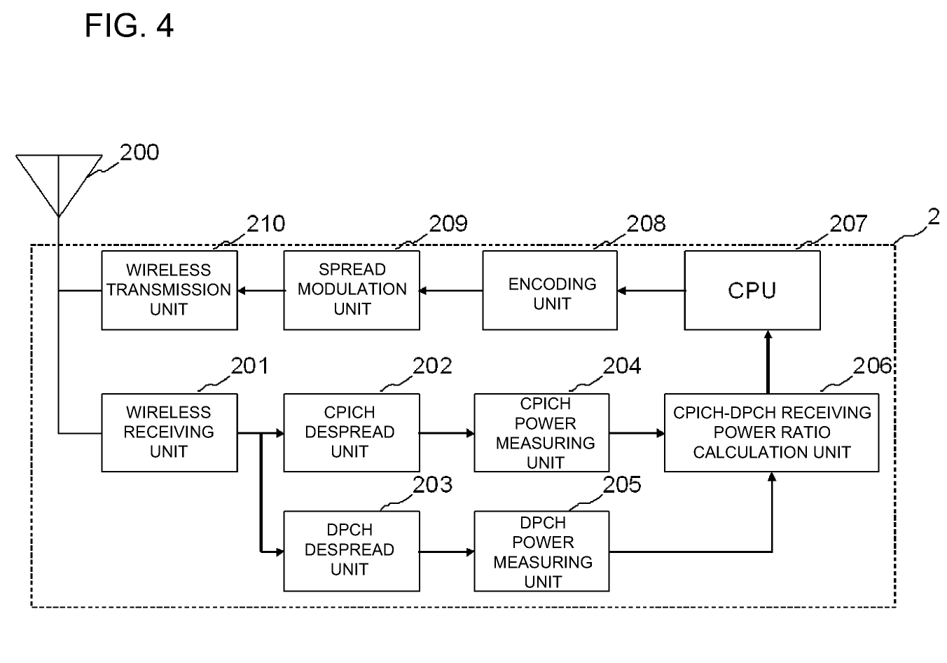

FIG. 4 is a block diagram showing a configuration example of a mobile station 2 (which is the same as that of a mobile station 3) in the second exemplary embodiment of the present invention. Referring to FIG. 4, a mobile station 200 including an antenna 200, a wireless receiving unit 201, a CPICH (Common Pilot Channel) despread unit 202, a DPCH despread unit 203, a CPICH power measuring unit 204, a DPCH power measuring unit 205, a CPICH-DPCH receiving power ratio calculation unit 206, a CPU (Central Processing Unit) 207, an encoding unit 208, a spread modulation unit 209, and a wireless transmission unit 210 is shown.

The antenna 200 performs high-frequency signal transmission/reception with a wireless base station 1.

The wireless receiving unit 201 performs frequency conversion of a high-frequency signal received through the antenna 200 into an intermediate frequency signal, and converts the received signal to a digital signal through A/D (Analog to Digital) conversion.

Each of the CPICH despread unit 202 and the DPCH despread unit 203 performs despreading and Rake synthesis of the digital signal from the wireless receiving unit 201.

Each of the CPICH power measuring unit 204 and the DPCH power measuring unit 205 measures receiving power of a physical channel through which signal reception has been performed.

The CPICH-DPCH receiving power ratio calculation unit 206 calculates a CPICH-DPCH receiving power ratio (Pd), based on information on the receiving power measured by the CPICH power measuring unit 204 and information on the receiving power measured by the DPCH power measuring unit 205.

The CPU 207 outputs the CPICH-DPCH receiving power ratio (Pd) to the encoding unit 208 in order to notify the CPICH-DPCH receiving power ratio (Pd) to the base station control unit 4 using an uplink individual channel.

The encoding unit 208 encodes transmitted data (CPICH-DPCH receiving power ratio (Pd)) output from the CPU 207.

The spread modulation unit 209 performs spread processing and modulation processing on the signal encoded by the encoding unit 208 and outputs a resulting signal to the wireless transmission unit 210.

The wireless transmission unit 210 converts the spread and modulated signal to a high-frequency signal and transmits the high-frequency signal to the wireless base station 1 through the antenna 200. The transmitted CPICH-DPCH receiving power ratio (Pd) is notified to the base station control device 4 through the wireless base station 1.

The above description was given about the configuration of the mobile station 2. Since configurations well known to those skilled in the art can be adopted for configurations of the other mobile station 3 and the wireless base station 1, descriptions of the configurations of the other mobile station 3 and the wireless base station 1 will be omitted.

Next, an operation of the base station control device 4 that operates based on the CPICH-DPCH receiving power ratio (Pd) notified from the mobile station 2 will be described.

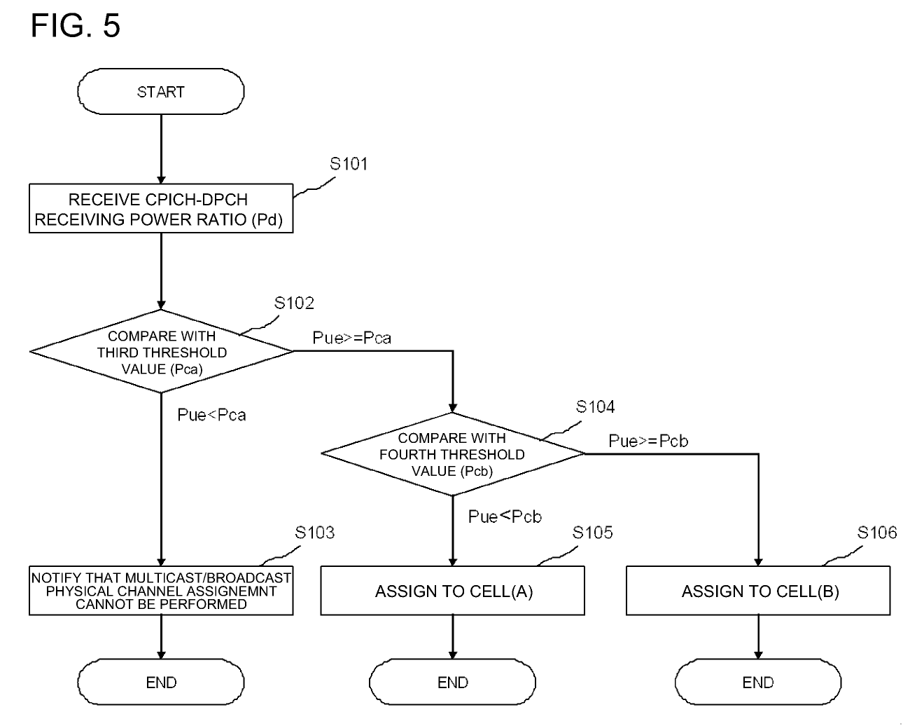

FIG. 5 is a flowchart showing the operation of the base station control device in the second exemplary embodiment of the present invention. Referring to FIG. 5, when the base station control device 4 receives the CPICH-DPCH receiving power ratio (Pd) (in step S101), the base station control device 4 first compares the CPICH-DPCH receiving power ratio (Pd) of a certain mobile station with a third threshold value (in step S102). As the third threshold value, a CPICH-SCCPCH transmission power ratio (Pca) of a cell(A) 5 with a large cell radius may be employed.

When it is found that the CPICH-DPCH receiving power ratio (Pd) of the mobile station is smaller than the third threshold value (Pca) as a result of comparison, the base station control device 4 determines that the mobile station concerned is located in a position to which physical channel assignment cannot be performed (because data through an SCCPCH transmitted with power lower than power of a DPCH cannot be received, on the basis of power of a CPICH). The base station control device 4 notifies a host device and the mobile station concerned that multicast/broadcast physical channel (SCCPCH) assignment cannot be performed (in step S103).

When the CPICH-DPCH receiving power ratio (Pd) for the mobile station is equal to or higher than the third threshold value (Pca), the base station control device 4 compares the CPICH-DPCH receiving power ratio (Pd) for the mobile station with a fourth threshold value (in step S104). As the fourth threshold value, a CPICH-SCCPCH transmission power ratio (Pcb) for a cell(B) 6 having a small cell radius may be used.

When the CPICH-DPCH receiving power ratio (Pd) of the mobile station is smaller than the fourth threshold value (Pcb) as a result of comparison, the base station control device 4 determines that the mobile station is located in a service area specific to the cell(A) 5 with the large cell radius (because the pertinent mobile station cannot receive data through an SCCPCH for the cell(B) having lower power than DPCH power), and assigns a physical channel (SCCPCH) corresponding to the cell(A) 5 to the mobile station (in step S105).

On the contrary, when the CPICH-DPCH receiving power ratio (Pd) of the mobile station is equal to or larger than the fourth threshold value (Pcb), the base station control device 4 determines that the mobile station is located in the service area of the cell(B) 6 with the small cell radius, and assigns a physical channel (SCCPCH) corresponding to the cell(B) 6 (in step S106).

As described above, the base station control device 4 compares the CPICH-DPCH receiving power ratio (Pd) of the mobile station with each of the third and fourth threshold values, and determines the physical channel (cell) to be assigned to the mobile station. As described above, this exemplary embodiment as well can assign different physical channels to a mobile station located in the vicinity of the wireless base station 1 and a mobile station located far from the wireless base station 1, thereby providing a high-quality service to each of the mobile stations under a reduced power consumption.

Further, in this exemplary embodiment, a distance between a mobile station and the wireless base station 1 can be grasped without using the wireless base station 1 described in the first exemplary embodiment. Thus, physical channel assignment can be implemented without changing the wireless base station 1.

The above description was given about the preferred exemplary embodiments of the present invention. The present invention is not limited to the exemplary embodiments described above. A further variation, a substitution, or an adjustment can be applied without departing from the basic technical concept of the present invention.

In each of the exemplary embodiments described above, for example, the description was given, assuming that SCCPCH transmission power information and a CVPICH-SCCPCH transmission power ratio of each cell is used as the first to fourth threshold values. These information and ratio may be corrected or modified and then used if necessary. The number of cells to be determined for use by one wireless base station according to the distance of a mobile station to the one wireless base station may be three or more. In that case, an appropriate threshold value is set for each of the cells.

The radius of each cell in each of the exemplary embodiments described above may be arbitrarily changed, and flexible cell design in which radio resources are efficiently used can be implemented. A small-sized cell (with a small radius) that supports an MBMS may be provided in a location such as a concert or event place on which people concentrate. In this case, an influence of the usage status of radio resources in the small-sized cell (with the small radius) on a cell outside the small-sized cell is limited.

Further, in each of the exemplary embodiments described above, the base station control device can also control the wireless base station such that a boundary between the outside cell and the inside cell is changed according to the usage status of radio resources.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A wireless communication system comprising:
a wireless base station thereof having a first cell that provides a multicast/broadcast service and a second cell with at least a portion thereof overlapping with said first cell, said wireless communication system further comprising:
a determining unit that for determines whether or not a mobile station is located in a service area of said second cell; and
an assigning unit that assigns a multicast/broadcast service physical channel corresponding to said second cell when said mobile station is located in said service area of said second cell and assigns a multicast/broadcast service physical channel corresponding to said first cell when said mobile station is not located in said service area of said second cell.

2. The wireless communication system according to claim 1, wherein said service area of said second cell is included in a service area of said first cell.

3. The wireless communication system according to claim 1, wherein according to whether transmission power information on said mobile station from said wireless base station exceeds a predetermined threshold value or not, it is determined whether or not said mobile station is located in said service area of said second cell.

4. The wireless communication system according to claim 1, wherein according to whether a Dedicated Physical Channel (DPCH)-Common Pilot Channel (CPICH) receiving power ratio observed at said mobile station exceeds a predetermined threshold value or not, it is determined whether or not said mobile station is located in said service area of said second cell.

5. The wireless communication system according to claim 1, wherein a threshold value is determined according to transmission power of said multicast-broadcast service physical channel corresponding to said second cell.

6. The wireless communication system according to claim 5 comprising:
a function of changing a radius of said second cell according to a multicast/broadcast service status in each of said first and second cells.

7. A base station control device of a wireless communication system with a wireless base station thereof having a first cell that provides a multicast/broadcast service and a second cell with at least a portion thereof overlapping with said first cell,
said base station control device comprising:
a determining unit that determines whether or not a mobile station is located in a service area of said second cell; and
an assigning unit that assigns a multicast/broadcast service physical channel corresponding to said second cell when said mobile station is located in said service area of said second cell and assigns a multicast/broadcast service physical channel corresponding to said first cell when said mobile station is not located in said service area of said second cell.

8. The base station control device according to claim 7, wherein said service area of said second cell is included in a service area of the first cell.

9. The base station control device according to claim 7, wherein according to whether transmission power information on said mobile station from said wireless base station exceeds a predetermined threshold value or not, it is determined whether or not said mobile station is located in said service area of said second cell.

10. The base station control device according to claim 7, wherein according to whether a Dedicated Physical Channel (DPCH)-Common Pilot Channel (CPICH) receiving power ratio observed at said mobile station exceeds a predetermined threshold value or not, it is determined whether or not said mobile station is located in said service area of said second cell.

11. The base station control device according to claim 7, wherein the threshold value is determined according to transmission power of said multicast-broadcast service physical channel corresponding to said second cell.

12. The base station control device according to claim 11 comprising:
a function of changing a radius of said second cell according to a multicast/broadcast service status in each of said first and second cells.

13. A wireless base station device comprising:
a detecting unit that detects a transmission power control bit included in data received through a Dedicated Physical Channel (DPCH);
transmission power information being calculated based on a value of the transmission power control bit and then being transmitted to a base station control device according to claim 9.

14. A mobile station device comprising:
a calculating unit that calculates a Dedicated Physical Channel (DPCH)-Common Pilot Channel (CPICH) receiving power ratio;
the receiving power ratio being transmitted to a base station control device according to claim 10.

15. A method of assigning a physical channel in a wireless communication system with a wireless base station thereof having a first cell that provides a multicast/broadcast service and a second cell with at least a portion thereof overlapping with said first cell, said method comprising:
determining whether or not a mobile station is located in a service area of said second cell; and
assigning a multicast/broadcast service physical channel corresponding to said second cell when said mobile station is located in said service area of said second cell and assigning a multicast/broadcast service physical channel corresponding to said first cell when said mobile station is not located in said service area of said second cell.
